(19) United States
(12) Patent Application Publication
(10) Pub. No.: US 2019/0178705 A1
(43) Pub. Date: Jun. 13, 2019

(54) ABNORMALITY DETECTING DEVICE, ABNORMALITY DETECTION METHOD, AND ABNORMALITY DETECTION COMPUTER PROGRAM

(71) Applicant: FUJITSU LIMITED, Kawasaki-shi (JP)

(72) Inventors: Yohei KISHI, Kawasaki (JP); Masanao SUZUKI, Yokohama (JP)

(73) Assignee: FUJITSU LIMITED, Kawasaki-shi (JP)

(21) Appl. No.: 16/210,195

(22) Filed: Dec. 5, 2018

(30) Foreign Application Priority Data
Dec. 7, 2017 (JP) 2017-235266

(51) Int. Cl. G01H 1/06; G01H 1/00; G01H 15/00

(52) U.S. Cl. CPC G01H 1/06; G01H 15/00; G01H 1/003

(57) ABSTRACT

An abnormality detecting device includes a processor coupled to a memory and configured to: detect an envelope of a sound signal representing a periodic sound emitted from the rotor including a predetermined number of blades and a periodic sound emitted from another object; perform a time frequency transform of the envelope for each of frames having a predetermined time length and calculate a frequency spectrum of the sound signal; detect a candidate of a frequency equivalent to a period of the sound emitted from the rotor; and obtain a duration in which a fluctuation in power with respect to power of a component of the frequency spectrum in the candidate detected with regard to the frame becomes lower than or equal to a certain level and identify the candidate in which the duration becomes longest as the frequency equivalent to the period of the sound emitted from the rotor.

### CROSS-REFERENCE TO RELATED APPLICATION

This application is based upon and claims the benefit of priority of the prior Japanese Patent Application No. 2017-235266, filed on Dec. 7, 2017, the entire contents of which are incorporated herein by reference.

### FIELD

The embodiment discussed herein is related to an abnormality detecting device, an abnormality detection method, and an abnormality detection computer program, which detect an abnormality of an object based on, for example, an audio signal.

### BACKGROUND

A technology for detecting abnormal sound emitted by machinery such as a fan, a motor, or a compressor based on a sound signal has been proposed. According to this technology, filtering is performed on a signal collected by a microphone, an envelope signal based on the signal on which the filtering has been performed is generated, and a cross-spectrum of the envelope signal and the unchanged collected signal is generated.

Another object that emits periodic sound may exist in the vicinity of a rotor such as a fan set as a target of the abnormality detection. In such a case, the sound signal collected via the microphone includes not only periodic sound based on a rotational vibration of the rotor which is emitted by the rotor but also the periodic sound emitted by the other object. In particular, for example, it may become difficult to identify the periodic sound emitted by the rotor in the sound signal in a case where a difference between a period of the sound emitted by the rotor and a period of the sound emitted by the other object is low. As a result, a false detection indicating that an abnormality has occurred in the rotor based on the sound emitted by the other object may be performed in some cases.

The following is a reference document.

### [Document 1] Japanese Laid-open Patent Publication No. 9-43283.

### SUMMARY

According to an aspect of the embodiments, an abnormality detecting device includes a memory, and a processor coupled to the memory and configured to: detect an envelope of a sound signal representing a periodic sound emitted from the rotor including a predetermined number of blades and a periodic sound emitted from another object; perform a time frequency transform of the envelope for each of frames having a predetermined time length and calculate a frequency spectrum of the sound signal for each of the frames; detect a candidate of a frequency equivalent to a period of the sound emitted from the rotor in the frame based on a peak included in the frequency spectrum with regard to the frame for each of the frames; and obtain a duration in which a fluctuation in power with respect to power of a component of the frequency spectrum in the candidate detected with regard to the frame becomes lower than or equal to a certain level for each of the frames and identify the candidate in which the duration becomes longest as the frequency equivalent to the period of the sound emitted from the rotor.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1A illustrates an example of a frequency spectrum obtained by performing a time frequency transform of an envelope signal of a sound signal generated when periodic sound emitted by a fan of an air conditioner is collected by a microphone;

FIG. 1B illustrates an example of a frequency spectrum in a case where not only the periodic sound emitted by the fan of the air conditioner but also periodic sound emitted by a compressor included in an exterior unit are collected by the microphone;

FIG. 2 is a schematic configuration diagram of an abnormality detecting device according to an embodiment;

FIG. 3 is a function block diagram of a processor included in the abnormality detecting device;

FIG. 4 is an overview explanatory diagram with regard to an estimation of a vibration frequency equivalent to a rotation period of the fan;

FIG. 5 is an overview explanatory diagram of a peak detection;

FIG. 6 illustrates an example of a relationship between a time change of a rotation speed of the fan and a time change of a rotation speed of the compressor;

FIG. 7 illustrates an example of candidates of peaks detected with regard to periods P1 to P3 illustrated in FIG. 6;

FIG. 8 illustrates an example of a frequency spectrum in the period P1 and a frequency spectrum in the period P2 in FIG. 6;

FIG. 9 illustrates an example of durations of candidates of peaks detected with regard to periods P1 to P3 illustrated in FIG. 7;

FIG. 10 is an overview explanatory diagram of an abnormality determination;

FIGS. 11A and 11B are operation flow chart of abnormality detection processing;

FIG. 12 represents an experiment result using the abnormality detecting device according to the present embodiment; and

FIG. 13 illustrates an example of a relationship between a rotational vibration of the fan and an abnormal sound generating period.

### DESCRIPTION OF EMBODIMENTS

Hereinafter, an abnormality detecting device, an abnormality detection used in the abnormality detecting device, and a computer program for an abnormality detection will be described with reference to the drawings. This abnormality detecting device generates a sound signal by collecting periodic sound emitted by a rotor including a plurality of blades such as a fan included in an air conditioner or the like by a microphone and performing a frequency analysis of the sound signal to detect an abnormality that has occurred in the rotor. However, when another object that emits periodic sound exists in the vicinity of the rotor as described above, the sound signal includes a component of the periodic sound (noise) emitted by the other object. For example, a compressor included in an exterior unit of the air conditioner may emit periodic sound in the vicinity of a fan of the air conditioner. In particular, for example, in a case where a difference between a period of the sound generated by a rotation of the compressor and a period of the sound generated by a rotational vibration of the fan is low, a difference between a frequency equivalent to a rotation period of the fan and a frequency equivalent to the period of the sound emitted by the compressor also becomes low in a frequency spectrum of the sound signal. For this reason, it becomes difficult to identify a frequency component equivalent to the rotation period of the fan and a frequency component equivalent to the period of the sound emitted by the period of the sound emitted by the compressor in the frequency spectrum of the sound signal. As a result, it becomes difficult to accurately determine whether or not an abnormality has occurred in the fan in some cases.

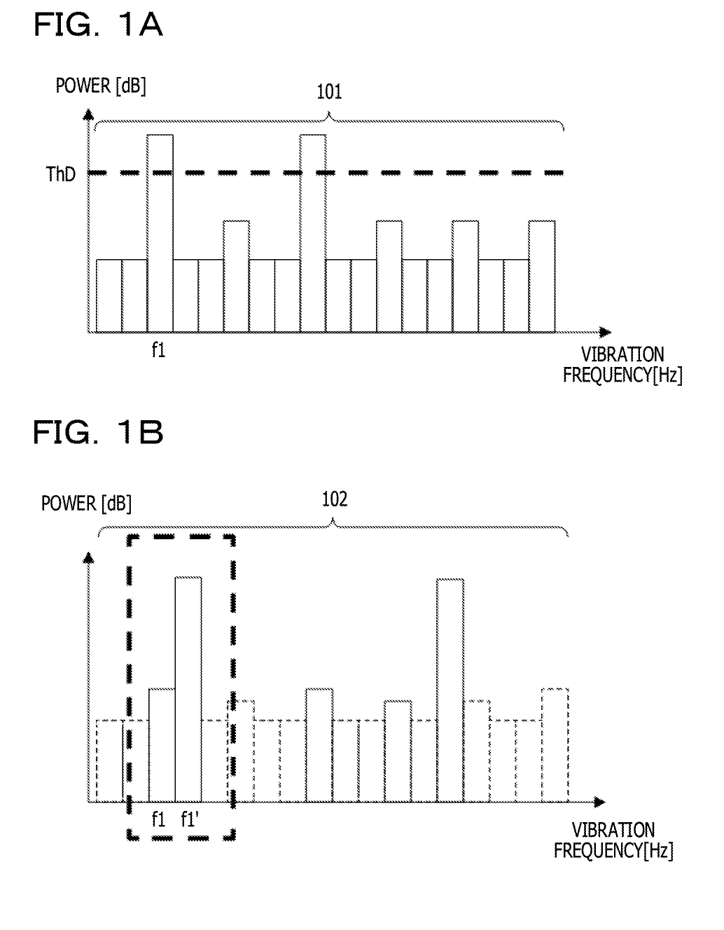

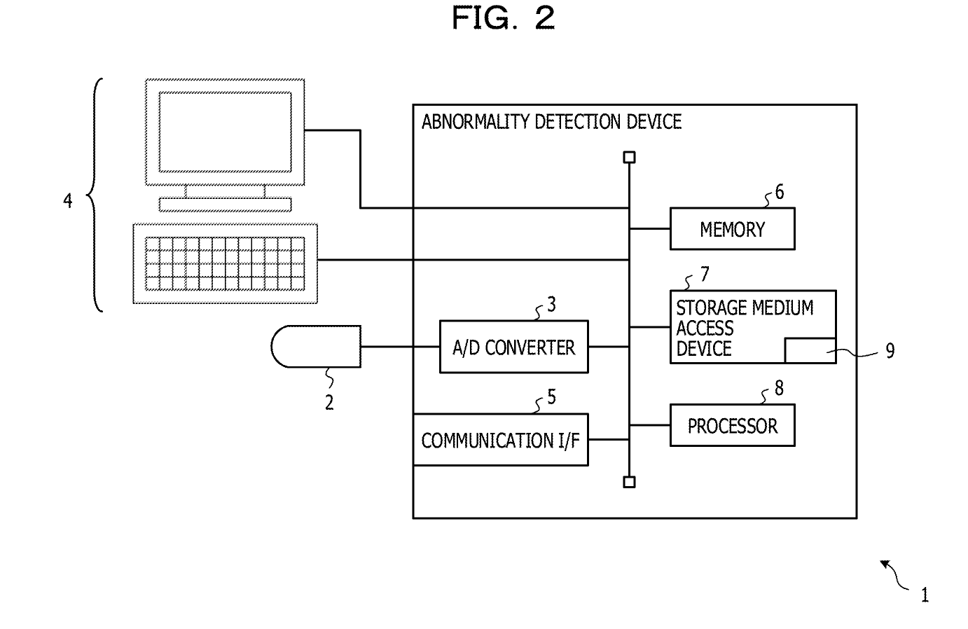

FIG. 1A illustrates an example of a frequency spectrum obtained by performing a time frequency transform of an envelope signal of the sound signal which is generated by collecting the periodic sound emitted by the fan of the air conditioner by the microphone. In FIG. 1A, the horizontal axis represents a frequency, and the vertical axis represents power. According to the present embodiment, the frequency spectrum represents a component of a frequency equivalent to a generating period of the sound generated by the rotational vibration of the fan instead of a high or low level of the sound. Hereinafter, the frequency will be referred to as a vibration frequency for convenience. A frequency spectrum 101 of the periodic sound emitted by the fan is represented by a set of individual bar graphs representing power for each vibration frequency. As indicated by the frequency spectrum 101, the power of the vibration is increased at a vibration frequency f1 corresponding to a period of the vibration generated by the fan and a vibration frequency corresponding to an integer multiple of the vibration frequency where peaks appear. When an abnormality occurs in a behavior of the fan, the power of the vibration exceeds a predetermined threshold ThD at the vibration frequency f1 corresponding to the period of the vibration generated by the fan and the vibration frequency corresponding to the integer multiple of the vibration frequency. For this reason, whether or not the abnormality has occurred in the fan is found based on the power of the individual vibration frequency.

FIG. 1B illustrates an example of the frequency spectrum in a case where not only the periodic sound emitted by the fan of the air conditioner but also the sound emitted by the compressor included in the exterior unit are collected by the microphone. In FIG. 1B, the horizontal axis represents the vibration frequency, and the vertical axis represents the power. A frequency spectrum 102 of the sound signal including the sound emitted by the compressor together with the periodic sound emitted by the fan is represented by a set of individual bar graphs representing power for each vibration frequency. In the frequency spectrum 102, a vibration frequency f1′ equivalent to the period of the sound emitted by the compressor is very close to the vibration frequency f1 equivalent to the period of the rotational vibration generated by the fan. As a result, since the frequency spectrum 102 has a peak at the vibration frequency f1′ due to a component included in the sound emitted by the compressor, no peak appears at the vibration frequency f1. For this reason, a magnitude of the component at the vibration frequency f1 is not checked, and a detection accuracy for the abnormality that has occurred in the fan is decreased.

A period during which the fan operates and a period during which the compressor operates are not necessarily matched with each other. In particular, for example, a period during which the period of the sound emitted by the compressor becomes fixed is shorter than a period (time) during which the period (cycle) of the sound emitted by the fan becomes fixed (that is, for example, a period during which the fan continues the rotation at a fixed speed). From this, the inventor has paid attention to a state in which a difference between the period of the sound emitted by the fan and the period of the sound emitted by the compressor becomes relatively high exists.

This abnormality detecting device obtains a candidate of the vibration frequency equivalent to the period of the rotational vibration generated by the fan from the frequency spectrum obtained from each of a plurality of frames in the sound signal obtained by collecting the sound emitted by the fan corresponding to an example of the rotor set as the abnormality detection target. This abnormality detecting device obtains a duration in which a fluctuation with respect to the power of the component in the frequency spectrum at the vibration frequency of the candidate detected from the frame becomes lower than or equal to a certain level with regard to the respective frames. This abnormality detecting device identifies the candidate where the duration becomes the longest as the vibration frequency equivalent to the rotation period of the fan and uses the component of the frequency spectrum at the identified vibration frequency to determine the presence or absence of the abnormality that has occurred in the fan.

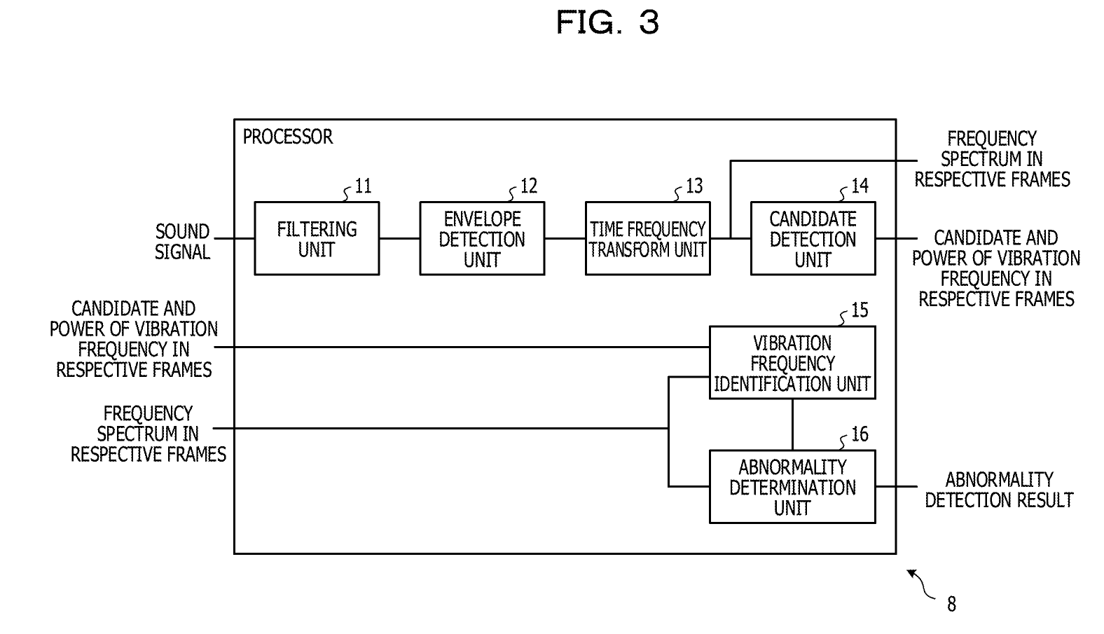

FIG. 2 is a schematic configuration diagram of the abnormality detecting device according to one embodiment. An abnormality detecting device 1 is implemented as a portable type device or a computer, for example. The abnormality detecting device 1 includes a microphone 2, an analog-to-digital converter 3, a user interface 4, a communication interface 5, a memory 6, a storage medium access device 7, and a processor 8.

The microphone 2 is an example of a sound input unit and is arranged in the vicinity of the fan corresponding to the abnormality detection target, for example. The microphone 2 generates an analog sound signal by collecting the periodic sound emitted from the fan. At this time, the periodic sound emitted by the compressor located in the vicinity of the fan is also collected by the microphone 2. For this reason, the sound signal includes not only the sound emitted from the fan but also the sound emitted from the compressor. The sound signal generated by the microphone 2 is input to the analog-to-digital converter 3.

The analog-to-digital converter 3 samples the analog sound signal received from the microphone 2 at a predetermined sampling frequency (for example, 16 kHz) to generate a digitalized sound signal. Hereinafter, for convenience of the explanation, the sound signal generated by collecting the sound by the microphone 2 and digitalized by the analog-to-digital converter 3 will be simply referred to as a sound signal.

The analog-to-digital converter 3 outputs the sound signal to the processor 8.

The user interface 4 includes a touch panel, for example. The user interface 4 generates an operation signal in accordance with an operation by a user such as, for example, a signal for instructing start of abnormality detection processing or a signal for displaying an abnormality detection result and outputs the operation signal to the processor 8. The user interface 4 displays the abnormality detection result or the like in accordance with the signal for the display which has been received from the processor 8. The user interface 4 may also separately include a plurality of operation buttons for inputting the operation signal and a display device such as a liquid crystal display.

The communication interface 5 includes a communication interface circuit that connects the abnormality detecting device 1 to another device such as, for example, the air conditioner including the fan corresponding to the abnormality detection target or the like in accordance with a predetermined communication standard. For example, the communication interface circuit may be set as a circuit that operates in accordance with a short-range wireless communication standard such as, for example, Bluetooth (registered trademark) or a circuit that operates in accordance with a serial bus standard such as a universal serial bus (USB). The communication interface 5 outputs information representing, for example, the abnormality detection result received from the processor 8 or the like to another device.

The memory 6 is an example of a storage unit and includes, for example, a readable and writable semiconductor memory and a read-only semiconductor memory. The memory 6 stores various computer programs and various data used in the abnormality detecting device 1. In particular, for example, the memory 6 stores various signals used in the abnormality detection processing or information such as the sound signal received from the analog-to-digital converter 3, various data generated in the midcourse of the abnormality detection processing, the abnormality detection result, and the like.

The storage medium access device 7 is another example of the storage unit and is a device that accesses a storage medium 9 such as, for example, a semiconductor memory card, a hard disc drive, or an optical storage medium. For example, the storage medium access device 7 reads a computer program stored in the storage medium 9 and executed on the processor 8 and supplies the computer program to the processor 8.

The processor 8 is an example of a control unit and includes, for example, a central processing unit (CPU) and its peripheral circuitry. The processor 8 may also include a processor for mathematical operations. The processor 8 controls the entirety of the abnormality detecting device 1.

The processor 8 also executes the abnormality detection processing with respect to the received sound signal.

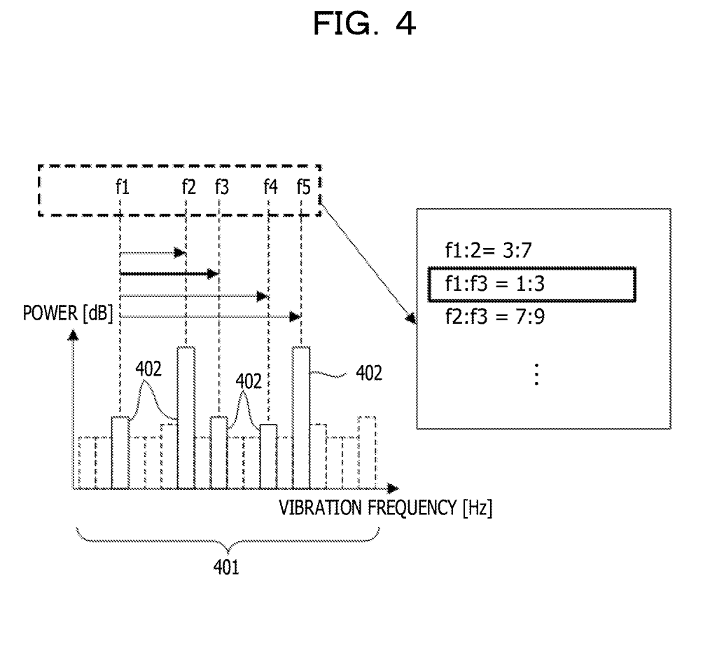

FIG. 3 is a function block diagram of the processor 8. The processor 8 includes a filtering section 11, an envelope detector 12, a time-to-frequency converter 13, a candidate detector 14, a vibration frequency estimator 15, and an abnormality determiner 16.

These respective units included in the processor 8 are functional modules realized by the computer program executed on the processor 8, for example. As an alternative to the above-mentioned configuration, these respective units may also be implemented as a dedicated-use calculation circuit implemented in part of the processor 8.

The filtering section 11 executes filtering processing with respect to the sound signal such that the vibration frequency component of the sound emitted by the fan is included, and the other vibration frequency component is attenuated. The filtering section 11 may attenuate a component at a frequency higher than a Nyquist frequency in accordance with the sampling frequency of the analog-to-digital converter 3 which is included in the sound signal. The filtering section 11 may also attenuate a component at a vibration frequency lower than the vibration frequency equivalent to the rotation period of the fan. For this reason, the filtering section 11 performs filtering on the sound signal by applying a low-pass filter or a band-pass filter formed by a finite impulse response (FIR) filter to the sound signal, for example. The filtering section 11 may also apply a filter in another format to the sound signal.

The filtering section 11 outputs the sound signal on which the filtering processing has been performed to the envelope detector 12.

The envelope detector 12 detects an envelope of the sound signal on which the filtering processing has been performed. Accordingly, a component representing a pitch of the sound is removed from the envelope of the sound signal. As a result, the analysis on the vibration frequency component of the sound emitted by the fan is facilitated. For this reason, the envelope detector 12 detects the envelope of the sound signal on which the filtering processing has been performed in accordance with the following expression, for example.

$$y ( t ) = {F}^{- 1} ( F ( \vert x ( t ) \vert ) \times W ( f ) ) \\ W ( f ) = \{ \begin{matrix}1 & \vert f \vert \leq fb \\ 0 & \vert f \vert > fb\end{matrix} \qquad ( 1 )$$

Where x(t) represents the sound signal on which the filtering processing has been performed, and y(t) represents the detected envelope. F( ) represents a fast Fourier transform (FFT), and F⁻¹( ) represents an inverse FFT. W(f) corresponds to a low-pass filter and is represented as a function on a frequency domain which becomes 1, for example, in a case where an absolute value of a frequency f becomes lower than or equal to a cutoff frequency fb and becomes 0 in a case where the absolute value of the frequency f is higher than the cutoff frequency fb. The cutoff frequency fb is desirably set to be substantially equal to a maximum frequency at which the filtering section 11 transmits, for example.

As an alternative to the above-mentioned configuration, the envelope detector 12 may also detect the envelope of the sound signal on which the filtering processing has been performed by using Hilbert transform as represented in the following expression.

$$y ( t ) = \vert \hat{x} ( t ) \vert \\ \hat{x} ( t ) = \{ \begin{matrix}{F}^{- 1} ( - j \times F ( x ( t ) ) ) & f < 0 \\ 0 & f = 0 \\ {F}^{- 1} ( + j \times F ( x ( t ) ) ) & f > 0\end{matrix} \qquad ( 2 )$$

The envelope detector 12 outputs the detected envelope to the time-to-frequency converter 13.

The time-to-frequency converter 13 converts each of a plurality of frames having a plurality of time length set in a time domain from the time domain to the frequency domain with regard to the detected envelope. Accordingly, the time-to-frequency converter 13 calculates a frequency spectrum of the sound signal including an amplitude component and a phase component with regard to each of the plurality of vibration frequencies for each frame.

According to the present embodiment, in the frequency domain, to detect the abnormality caused by the rotational vibration of the fan, the frequency spectrum is desirably calculated at a sufficient accuracy with regard to an interval from 0 to a vibration frequency equivalent to the rotation speed of the fan×the number of blades included in the fan. For this reason, for example, a resolution of approximately 1 [Hz] is preferably obtained in the frequency domain. For example, when the sampling frequency of the analog-to-digital converter 3 is 16 kHz, a frame length desirably has at least a length equivalent to 16384 samples such as, for example, a range between 16384 samples and 16384×60 samples (that is, for example, 1 minute).

The time-to-frequency converter 13 transforms the respective frames set with regard to the envelope from the time domain into the frequency domain to calculate the frequency spectrum for each frame. For example, the time-to-frequency converter 13 may calculate the frequency spectrum by executing the time frequency transform such as FFT with respect to the respective frames.

The time-to-frequency converter 13 saves the frequency spectrum calculated with regard to the respective frames in the memory 6 and also outputs the frequency spectrum to the candidate detector 14.

The candidate detector 14 detects the candidate of the vibration frequency equivalent to the rotation period of the fan based on the frequency spectrum for each frame. Since it is sufficient when the candidate detector 14 executes the same processing with regard to the respective frames, hereinafter, the processing with respect to a single frame will be described.

In a case where an abnormality exists in the fan, for example, a shaft of the fan vibrates along rotation of the fan. As a result, the fan generates abnormal sound. In this case, the vibration of the shaft of the fan becomes practically equal to the rotation period of the fan. As an alternative to the above-mentioned configuration, a foreign matter may collide with a blade of the fan. In this case, abnormal sound is generated every period obtained by dividing the rotation period of the fan by the number of blades included in the fan. Therefore, peaks appear at the vibration frequency equivalent to the rotation period of the fan and the vibration frequency obtained by multiplying the vibration frequency equivalent to the rotation period of the fan by the number of blades included in the fan in the frequency spectrum of the sound generated by the rotational vibration of the fan.

The candidate detector 14 detects the peaks from the frequency spectrum and calculates a ratio of the higher vibration frequency to the lower vibration frequency with regard to each of pairs including two peaks among the detected peaks. The candidate detector 14 identifies the pair having the ratio closest to the number of blades included in the fan and sets the lower vibration frequency in the identified pair as the candidate of the vibration frequency equivalent to the rotation period of the fan. In this example, it is supposed that the number of blades included in the fan is already found.

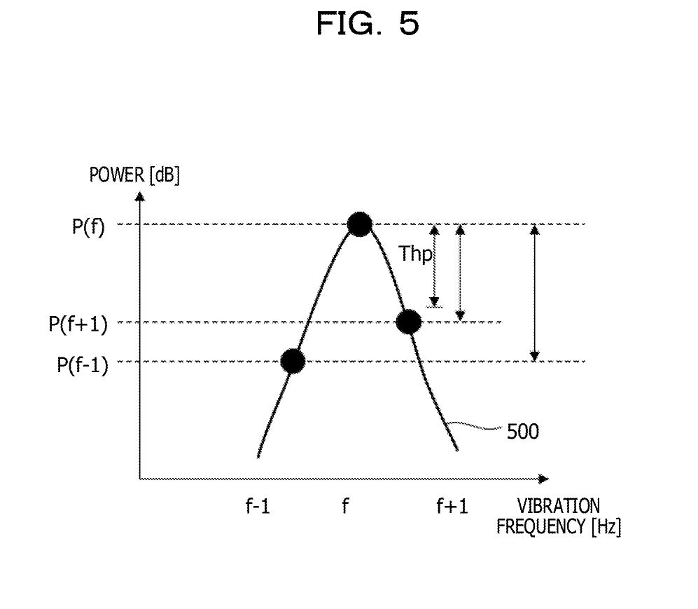

FIG. 4 is an overview explanatory diagram with regard to an estimation of the vibration frequency equivalent to the rotation period of the fan. In FIG. 4, the horizontal axis represents the vibration frequency, and the vertical axis represents the power. The frequency spectrum 401 with regard to the envelope of the sound signal obtained by the microphone 2 is represented by a set of individual bar graphs representing power at each vibration frequency. In this example, the number of blades included in the fan is set as 3.

A peak 402 is extracted at each of the vibration frequencies f1 to f5 in the frequency spectrum 401. A ratio of the mutual vibration frequencies corresponding to the peaks (such as f2/f1, f3/f1, or f3/f2) is calculated for each pair including two peaks among the extracted peaks 402. In this example, the ratio (f3/f1) is the closest to the number ‘3’ of blades included in the fan. For this reason, the vibration frequency f1 is detected as the candidate of the vibration frequency equivalent to the rotation period of the fan.

When the peaks are detected from the frequency spectrum, for each vibration frequency, the candidate detector 14 compares the power of the component at the vibration frequency in the frequency spectrum with the power of the component at the adjacent vibration frequency. For example, the candidate detector 14 detects, the vibration frequency having the power than the power of the adjacent vibration frequency by an amount higher than or equal to a peak detection threshold, that is, for example, the vibration frequency that satisfies conditions of the following expression as the peak.

Pf(k)=f provided that {P(f)−P(f−1)}≥Thp

and also {P(f)−P(f+1)}≥Thp (3)

Where P(f−1), P(f), and P(f+1) respectively represent power of components at the vibration frequencies included in the frequency spectrum with regard to the vibration frequencies (f−1), f, and (f+1). Thp represents the peak detection threshold and is set as 1 dB, for example. Pf(k) represents the vibration frequencies of the k (k=1, 2, . . . )-th peaks in the ascending order in terms of the vibration frequency.

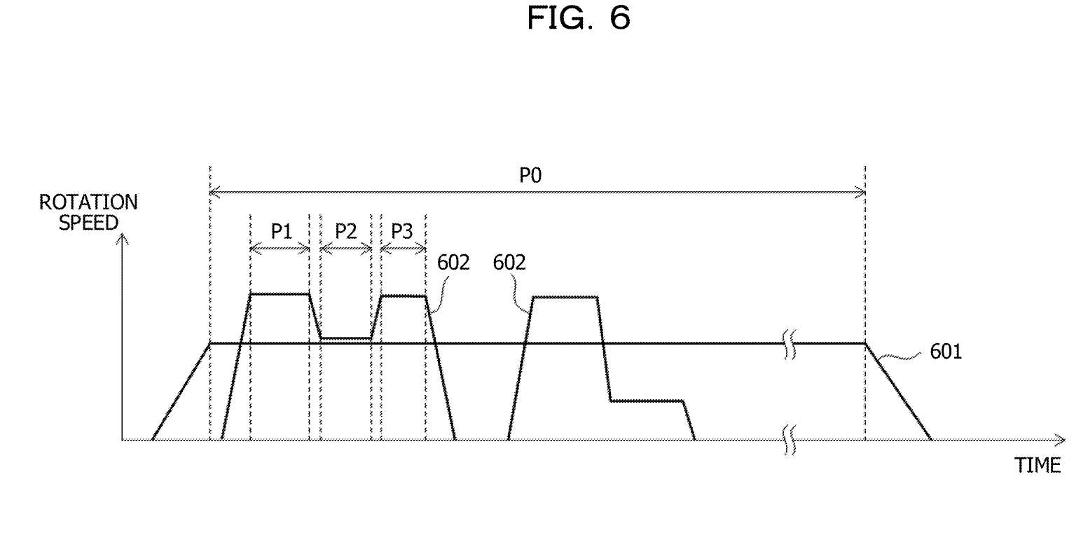

FIG. 5 is an overview explanatory diagram of a peak detection. In FIG. 5, the horizontal axis represents the vibration frequency, and the vertical axis represents the power. A waveform 500 represents the frequency spectrum. In this example, the power P(f) at the vibration frequency f is higher than both the power P(f−1) at the vibration frequency (f−1) and the power P(f+1) at the vibration frequency (f+1) by the amount higher than or equal to the peak detection threshold Thp. For this reason, the vibration frequency f is detected as the peak.

When the peaks are detected, the candidate detector 14 calculates the ratio of the vibration frequencies corresponding to the peaks for each pair of the peaks in accordance with the following expression.

R(I)=Pf(j)/Pf(i)provided that Pf(j)>Pf(i) (4)

Where, R(I) (I=1, 2, . . . , _{M}C₂, and M denotes the total number of detected peaks) represents the ratio of the vibration frequencies calculated with regard to the l-th pair of peaks including the i-th peak and the j-th peak (provide that Pf(j)>Pf(i)).

The candidate detector 14 identifies the pair closest to the number N of blades included in the fan among the ratios R(I) of the vibration frequencies calculated with respect to the pairs of the respective peaks. That is, for example, the candidate detector 14 identifies the pair of the peaks satisfying the following expression.

$${min}_{i} ( \vert R ( l ) - N \vert ) \qquad ( 5 )$$

The candidate detector 14 detects the vibration frequency equivalent to the lower peak among the two peaks included in the identified pair as the candidate of the vibration frequency equivalent to the rotation period of the fan.

In a case where a minimum value of an absolute value of a difference between the ratio R(I) and the number N of blades included in the fan is higher than a predetermined threshold, it is sufficient when the candidate detector 14 detects or does not detect the candidate of the vibration frequency equivalent to the rotation period of the fan. The predetermined threshold is set in a range between 0.5 and 1, for example.

For each frame, the candidate detector 14 saves the candidate of the vibration frequency equivalent to the rotation period of the fan and the value of the power in the candidate detected with regard to the frame in the memory 6.

The vibration frequency estimator 15 identifies the vibration frequency equivalent to the rotation period of the fan from the candidates of the vibration frequency equivalent to the rotation period of the fan detected from the respective frames.

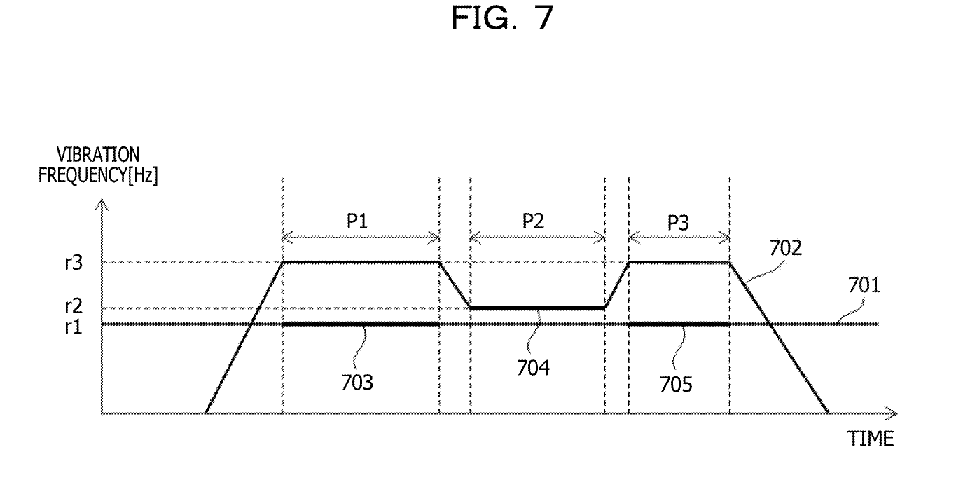

FIG. 6 illustrates an example of a relationship between a time change of a rotation speed of the fan and a time change of a rotation speed of the compressor. In FIG. 6, the horizontal axis represents the time, and the vertical axis represents the rotation speed. A waveform 601 represents the time change of the rotation speed of the fan, and a waveform 602 represents the time change of the rotation speed of the compressor. As illustrated in the waveform 601 and the waveform 602, the rotation speed of the compressor changes numerous times in the period P0 during which the rotation speed of the fan becomes fixed. For example, although a difference between the rotation speed of the compressor and the rotation speed of the fan during the periods P1 and P3 in the period P0 is relatively high, the difference between the rotation speed of the compressor and the rotation speed of the fan is very low in the period P2.

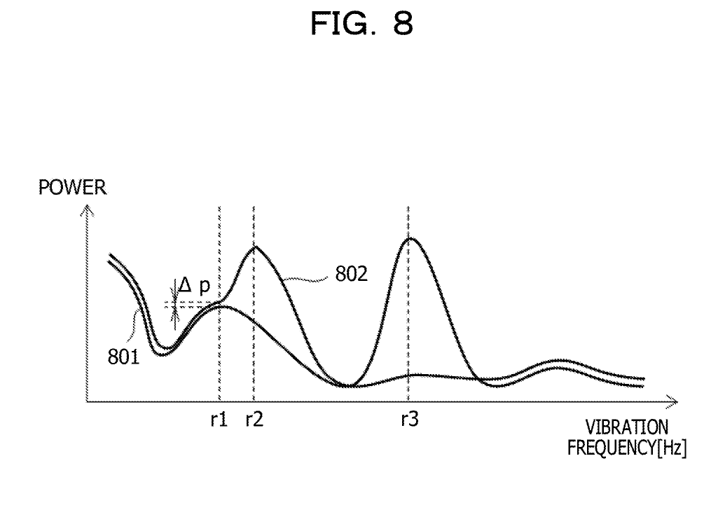

FIG. 7 illustrates an example of the candidate of the vibration frequency equivalent to the rotation period of the fan detected with regard to the periods P1 to P3 illustrated in FIG. 6. In FIG. 7, the horizontal axis represents the time, and the vertical axis represents the vibration frequency. A waveform 701 represents a time change of the vibration frequency equivalent to the rotation period of the fan, and a waveform 702 represents a time change of the vibration frequency equivalent to the rotation period of the compressor. Lines 703 to 705 respectively represent the candidates of the vibration frequency equivalent to the rotation period of the fan detected in the respective periods. In this example, since a difference between the vibration frequency equivalent to the rotation period of the fan r1 and the vibration frequency r3 equivalent to the rotation period of the compressor is high in the periods P1 and P3, as indicated by the line 703 and the line 705, the vibration frequency r1 is detected as the candidate. On the other hand, since a difference between the vibration frequency equivalent to the rotation period of the fan r1 and the vibration frequency r2 equivalent to the rotation period of the compressor is very low in the period P2, as indicated by the line 704, the vibration frequency r2 is detected as the candidate instead of the vibration frequency r1.

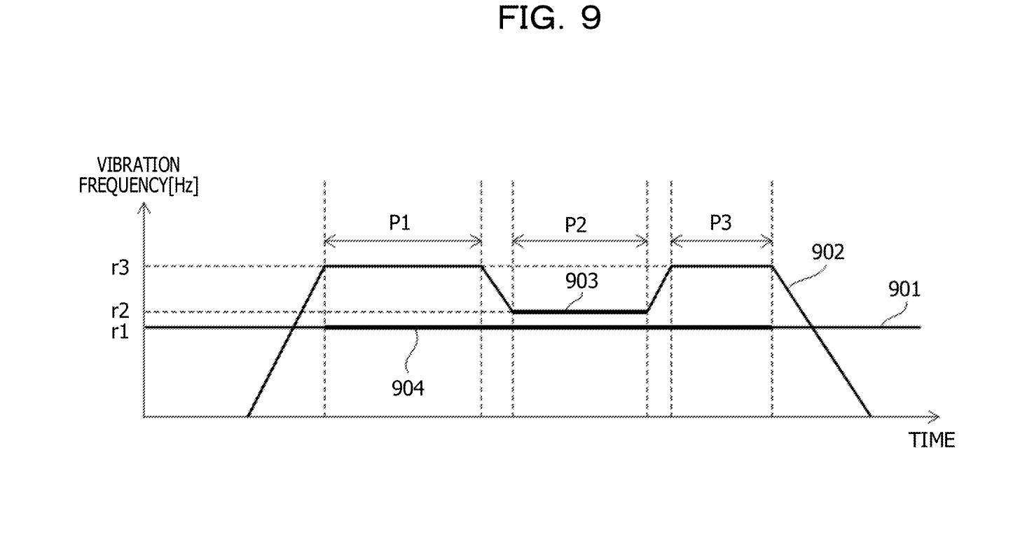

FIG. 8 illustrates an example of the frequency spectrum in the period P1 and the frequency spectrum in the period P2 in FIG. 6. In FIG. 8, the horizontal axis represents the vibration frequency, and the vertical axis represents the power. A waveform 801 represents the frequency spectrum in the period P1, and a waveform 802 represents the frequency spectrum in the period P2. As illustrated in the waveform 801, since a difference between the rotation speed of the fan and the rotation speed of the compressor in the period P1 is high, peaks respectively appear at the vibration frequency r1 and the vibration frequency r3. Although not illustrated in the drawing, the peak appears at the vibration frequency corresponding to a value obtained by multiplying the vibration frequency r1 by the number of blades included in the fan. For this reason, the vibration frequency r1 is detected as the candidate of the vibration frequency equivalent to the rotation period of the fan.

On the other hand, as illustrated in the waveform 802, since the difference between the rotation speed of the fan and the rotation speed of the compressor in the period P2 is very low, the peak appears at the vibration frequency r2, and no peak appears at the vibration frequency r1. As a result, the vibration frequency r2 equivalent to the rotation period of the compressor is detected as the candidate of the vibration frequency equivalent to the rotation period of the fan. Since the fan also rotates at the same rotation speed in the period P2 as the rotation speed in the period P1, a difference ΔP between the power at the vibration frequency r1 in the period P1 and the power at the vibration frequency r1 in the period P2 is low.

The vibration frequency estimator 15 obtains a duration in which the fluctuation in the power with respect to the power of the component in the frequency spectrum in the candidate of the vibration frequency equivalent to the rotation period of the fan detected with regard to the frame becomes lower than or equal to a fixed level with regard to the respective frames. The vibration frequency estimator 15 identifies the vibration frequency equivalent to the candidate where the duration becomes the longest as the vibration frequency equivalent to the rotation period of the fan.

To obtain the duration, the vibration frequency estimator 15 calculates a difference of the power of the component in the frequency spectrum in the candidate of the vibration frequency equivalent to the rotation period of the fan detected from a frame of interest between the frame of interest and the respective frames included in the periods before and after the frame of interest. The vibration frequency estimator 15 sets a time when the frames where the absolute value of the difference becomes lower than or equal to a predetermined fluctuation threshold continue as the duration in which the fluctuation in the power with regard to the candidate of the frame of interest becomes lower than or equal to a certain level. Respective lengths of the period before the frame of interest and the period after the frame of interest are set as five minutes, for example. A period used for determining the duration may be set in only one of the time before the frame of interest and the time after the frame of interest. In this case, a length of the period may be set as ten minutes, for example. The predetermined fluctuation threshold is set as 1 dB, for example.

The vibration frequency estimator 15 sequentially compares the absolute value of the difference with the predetermined fluctuation threshold from a frame adjacent to the frame of interest in a direction to be away from the frame of interest, for example. With regard to both the period before the frame of interest and the period after the frame of interest, the vibration frequency estimator 15 sets the number of continuous frames where the absolute value of the difference becomes lower than or equal to the predetermined fluctuation threshold as the duration in which the fluctuation in the power becomes lower than or equal to the certain level with regard to the candidate of the frame of interest.

When a predetermined number or more of frames where the absolute value of the difference is higher than the predetermined fluctuation threshold continues in the period before the frame of interest, the vibration frequency estimator 15 may determine that the fluctuation in the power is lower than or equal to the certain level from the frame of interest up to the frame immediately after the continuous frames. That is, for example, when the number of continuous frames where the absolute value of the difference becomes lower than or equal to the predetermined fluctuation threshold is lower than the predetermined number, the vibration frequency estimator 15 sets that the fluctuation in the power is lower than or equal to the certain level in the continuous frames too. Similarly, when a predetermined number or more of frames where the absolute value of the difference is higher than the predetermined fluctuation threshold continues in the period after the frame of interest, the vibration frequency estimator 15 may determine that the fluctuation in the power is lower than or equal to the certain level from the frame of interest up to the frame immediately before the continuous frames. The predetermined number may be set as three, for example.

As an alternative to the above-mentioned configuration, the vibration frequency estimator 15 may also determine that the fluctuation in the power is lower than or equal to the certain level up to the frame farthest from the frame of interest where the absolute value of the difference becomes lower than or equal to the predetermined fluctuation threshold among the respective frames in the period before the frame of interest. Similarly, the vibration frequency estimator 15 may also determine that the fluctuation in the power is lower than or equal to the certain level up to the frame farthest from the frame of interest where the absolute value of the difference becomes lower than or equal to the predetermined fluctuation threshold among the respective frames in the period after the frame of interest.

The vibration frequency estimator 15 performs the comparison of the duration of the candidate of the vibration frequency equivalent to the rotation period of the fan detected for each frame. The vibration frequency estimator 15 identifies the candidate in which the duration becomes the longest as the vibration frequency equivalent to the rotation period of the fan.

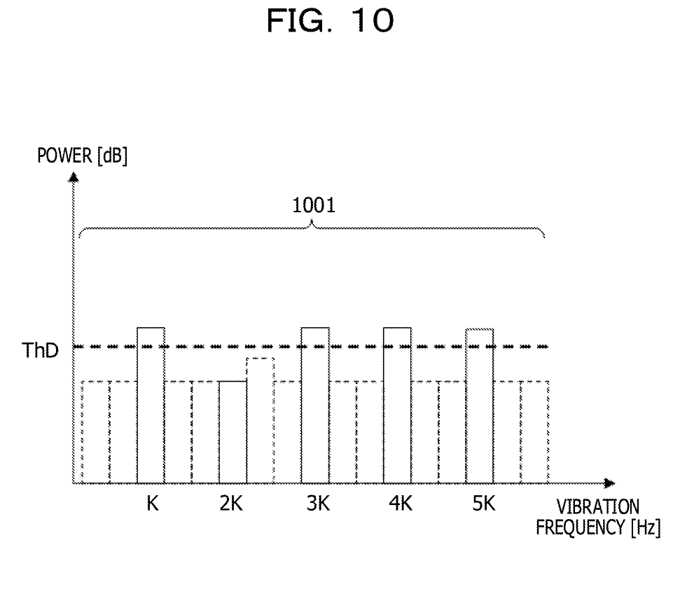

FIG. 9 illustrates an example of the duration of the candidate of the vibration frequency equivalent to the rotation period of the fan detected with regard to the periods P1 to P3 illustrated in FIG. 7. In FIG. 9, the horizontal axis represents the time, and the vertical axis represents the vibration frequency. A waveform 901 represents a time change of the vibration frequency equivalent to the rotation period of the fan, and a waveform 902 represents a time change of the vibration frequency equivalent to the period of the sound emitted by the compressor. A line 903 represents duration with regard to the candidate of the vibration frequency detected from the frame in the period P2. On the other hand, a line 904 represents duration with regard to the candidate of the vibration frequency detected from the frame in the period P1 or the period P3. In this example, the power of the component in the frequency spectrum at the vibration frequency r2 relies on the period of the sound emitted by the compressor such as, for example, the rotation speed of the compressor instead of the rotation period of the fan. For this reason, the power at the vibration frequency r2 also largely changes in accordance with the change in the rotation speed of the compressor. Therefore, as indicated by the line 903, the duration obtained with regard to the vibration frequency r2 detected as the candidate is also limited to the period P2 during which the rotation speed of the compressor is fixed at the rotation speed corresponding to the vibration frequency r2. On the other hand, even when the rotation speed of the compressor fluctuates, the power does not change much at the vibration frequency equivalent to the actual rotation period of the fan r1. For this reason, as indicated by the line 904, in a case where the vibration frequency equivalent to the actual rotation period of the fan r1 is detected as the candidate, the duration becomes a length across the entirety of the periods P1 to P3. Therefore, the vibration frequency r1 which has the longer duration among the vibration frequencies r1 and r2 is identified as the vibration frequency equivalent to the rotation period of the fan.

The vibration frequency estimator 15 notifies the abnormality determiner 16 of the identified vibration frequency equivalent to the rotation period of the fan.

The abnormality determiner 16 selects one of the frames where it is determined that the fluctuation in the power becomes lower than or equal to the certain level with regard to the identified vibration frequency equivalent to the rotation period of the fan. With regard to the selected frame, the abnormality determiner 16 compares the power of the component at the vibration frequency included in the frequency spectrum with an abnormality determination threshold with regard to both the vibration frequency equivalent to the rotation period of the fan and the vibration frequency corresponding to the integer multiple of the vibration frequency. This is because it is estimated that the abnormal sound generated by the behavior of the fan relies on the rotation period of the fan. The abnormality determiner 16 determines that the abnormal sound is generated and some abnormality exists in the fan in a case where the power is higher than or equal to the abnormality determination threshold at one of the vibration frequency equivalent to the rotation period of the fan and vibration frequencies corresponding to integral multiples of the identified vibration frequency. The abnormality determination threshold is set as 3 dB, for example. On the other hand, in a case where the power is lower than the abnormality determination threshold at any of the vibration frequency equivalent to the rotation period of the fan and the vibration frequencies corresponding to the integer multiples of the vibration frequency, the abnormality determiner 16 determines that the abnormal sound is not generated, and the abnormality does not exists in the fan. The abnormality determiner 16 may also compare the absolute value of the amplitude component at the respective vibration frequencies described above with the abnormality determination threshold instead of the comparison of the powers of the components at the respective vibration frequencies described above with the abnormality determination threshold. The abnormality determiner 16 may determine that the abnormality occurs in the fan in a case where the absolute value of the amplitude component becomes higher than or equal to the abnormality determination threshold at one of the vibration frequencies.

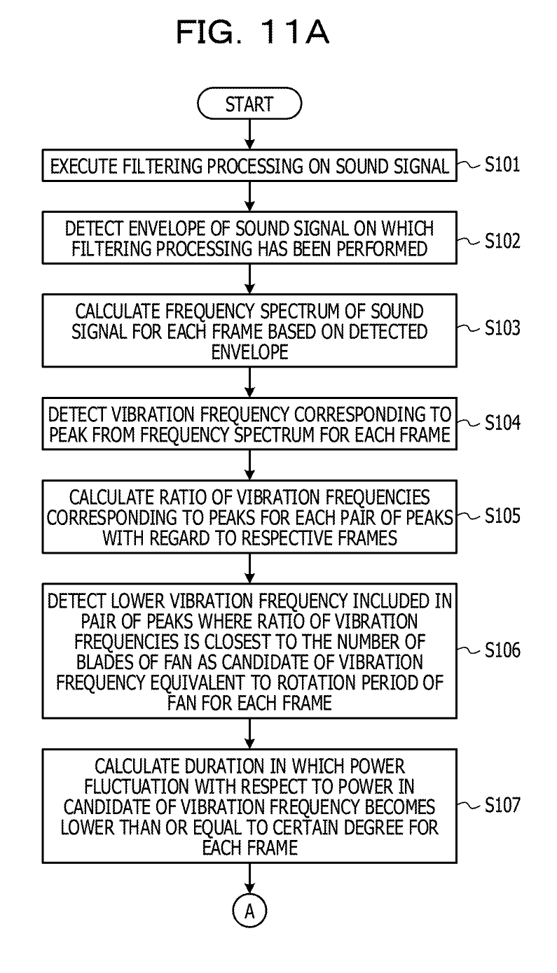

FIG. 10 is an overview explanatory diagram of an abnormality determination. In FIG. 10, the horizontal axis represents the vibration frequency, and the vertical axis represents the power. The frequency spectrum of the sound signal 1001 obtained by the microphone 2 is represented by a set of individual bar graphs representing power for each vibration frequency. In this example, the vibration frequency K is the vibration frequency equivalent to the rotation period of the fan. Therefore, the power at the vibration frequency K, 2K, 3K, . . . is compared with the abnormality determination threshold ThD. In this example, since the power at each of the vibration frequencies K, 3K, 4K, and 5K is higher than or equal to the abnormality determination threshold ThD, the abnormality determiner 16 determines that some abnormality exists in the fan.

The abnormality determiner 16 causes the user interface 4 to display the abnormality detection result. As an alternative to the above-mentioned configuration, the abnormality determiner 16 may also generate a signal including the abnormality detection result and output the signal to another device via the communication interface 5.

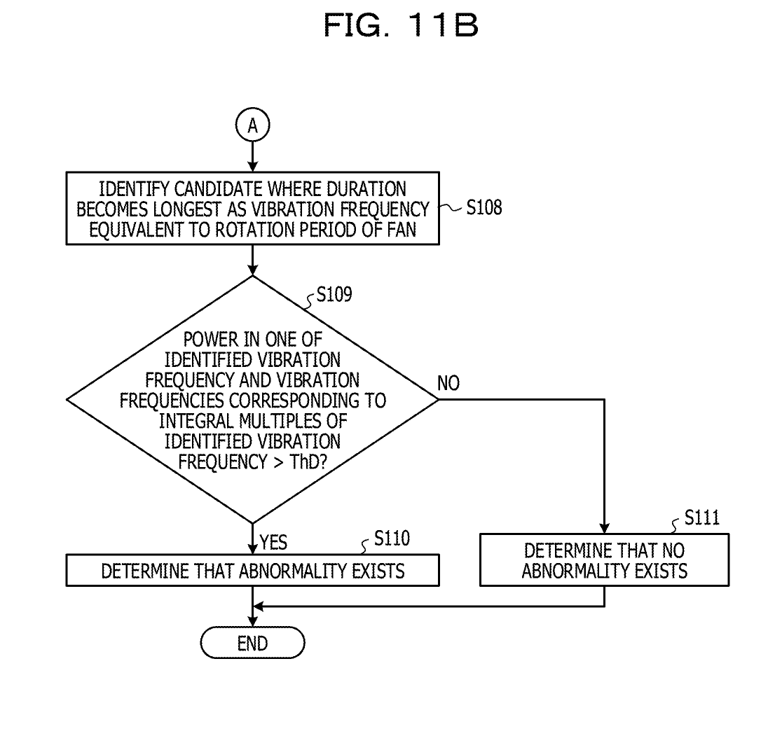

FIGS. 11A and 11B are operation flow chart of the abnormality detection processing. When the sound signal is obtained, the processor 8 executes the abnormality detection processing in accordance with the following operation flow chart.

The filtering section 11 executes the filtering processing on the sound signal including the sound emitted from the fan collected by the microphone 2 such that the vibration frequency components of the sound emitted from the fan are included, and the other vibration frequency components attenuate (step S101). The envelope detector 12 detects an envelope of the sound signal on which the filtering processing has been performed (step S102).

The time-to-frequency converter 13 performs the transform from the time domain into the frequency domain in units of the frame to calculate the frequency spectrum of the sound signal for each frame with regard to the detected envelope (step S103).

The candidate detector 14 detects the vibration frequency corresponding to the peak from the frequency spectrum for each frame (step S104). When the peaks are detected for each frame, the candidate detector 14 calculates the ratio of the vibration frequencies corresponding to the peaks for each pair of the peaks (step S105). The candidate detector 14 identifies the pair having the value of the ratio closest to the number of blades included in the fan among the ratios of the vibration frequencies calculated with regard to the respective pair of the peaks for each frame. The candidate detector 14 detects the lower vibration frequency included in the identified pair as the candidate of the vibration frequency equivalent to the rotation period of the fan (step S106).

The vibration frequency estimator 15 calculates a duration when the power fluctuation with respect to the power of the component in the frequency spectrum in the detected candidate of the vibration frequency becomes lower than or equal to a certain degree for each frame (step S107). The vibration frequency estimator 15 identifies the vibration frequency with regard to the candidate where the duration becomes the longest among the detected candidates with regard to the respective frames as the vibration frequency equivalent to the rotation period of the fan (step S108).

The abnormality determiner 16 determines whether or not the power of the component at the vibration frequency included in the frequency spectrum is higher than or equal to the abnormality determination threshold ThD with regard to one of the vibration frequency equivalent to the estimated rotation period of the fan and the vibration frequencies corresponding to the integral multiples of the identified vibration frequency (step S109). In a case where the power is higher than or equal to the abnormality determination threshold ThD with regard to one of the vibration frequency equivalent to the rotation period of the fan and the vibration frequencies corresponding to the integral multiples of the identified vibration frequency (step S109—Yes), the abnormality determiner 16 determines that the abnormality exists in the fan (step S110). The abnormality determiner 16 causes the user interface 4 to display the abnormality detection result indicating that the abnormality exists in the fan.

On the other hand, in a case where the power is lower than the abnormality determination threshold ThD with regard to any of the vibration frequency equivalent to the rotation period of the fan and the vibration frequencies corresponding to the integer multiples of the vibration frequency (step S109-No), the abnormality determiner 16 determines that no abnormality exists in the fan (step S111). The abnormality determiner 16 causes the user interface 4 to display the abnormality detection result indicating that no abnormality exists in the fan.

After step S110 or S111, the processor 8 ends the abnormality detection processing.

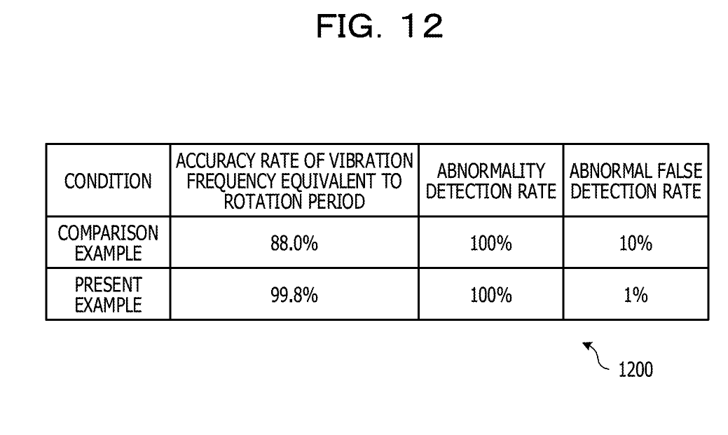

FIG. 12 represents an experimental result using the abnormality detecting device 1 according to the present embodiment. In this experiment, the abnormality detection processing is executed by using the abnormality detecting device 1 with respect to the sound signal for 700 minutes (including a period of 300 minutes during which the abnormality occurs) obtained with regard to four external units of an air conditioner. In a table 1200 illustrated in FIG. 12, an accuracy rate of the vibration frequency equivalent to the detected rotation period of the fan, a detection rate of the abnormality that has occurred in the fan, and a false detection rate at which an abnormality is falsely detected are represented in the stated order from the left column. A top field represents a result in a case where the candidate of the vibration frequency equivalent to the rotation period of the fan obtained with regard to the respective frames is set as the vibration frequency equivalent to the rotation period of the fan as a comparison example. A bottom field represents a result in a case where the abnormality detection processing is executed by the abnormality detecting device 1 according to the present embodiment. As illustrated in the table 1200, according to the comparison example, the accuracy rate of the vibration frequency equivalent to the rotation period of the fan is 88.0%, and according to the present embodiment, the accuracy rate is improved to 99.8%. The abnormality detection rate becomes 100% in both the comparison example and the present embodiment. The abnormality false detection rate in the comparison example is 10%, and according to the present embodiment, the abnormality false detection rate is decreased to 1%. In this manner, it is understood that the abnormality detecting device 1 according to the present embodiment may more accurately identify the vibration frequency equivalent to the rotation period of the fan and suppress the abnormality false detection.

As described above, this abnormality detecting device detects the candidate of the vibration frequency equivalent to the rotation period of the rotor from the frequency spectrum of the respective frames of the sound signal representing the sound emitted from the rotor. The abnormality detecting device obtains the duration in which the fluctuation in the power with respect to the power of the component in the frequency spectrum in the detected candidate becomes lower than or equal to a certain level for each frame. The abnormality detecting device identifies the vibration frequency of the candidate in which the duration becomes the longest as the vibration frequency equivalent to the rotation period of the rotor. For this reason, this abnormality detecting device may identify the vibration frequency equivalent to the period of the sound generated by the rotational vibration of the rotor even in a case where an object such as a compressor that generates periodic noise exists in the vicinity of the rotor. Therefore, this abnormality detecting device may accurately determine the presence or absence of the abnormality that has occurred in the rotor based on the vibration frequency component of the sound generated by the rotational vibration of the rotor included in the frequency spectrum.

According to a modified example, the abnormality detecting device may also obtain operation information indicating whether or not the rotor currently performs a rotation operation from a device including the rotor set as the target of the abnormality detection such as, for example, the air conditioner including the fan. The operation information may be set as information representing power consumption of the device including the rotor such as, for example, information representing power consumption of the exterior unit in which the fan is arranged, for example. The vibration frequency estimator 15 may refer to the operation information and obtain the duration of the candidate of the vibration frequency equivalent to the rotation period of the rotor based on the frame when the rotor performs the rotation operation. The vibration frequency estimator 15 may determine that the rotor performs the rotation operation when a power consumption value represented by the operation information is higher than or equal to a threshold equivalent to a minimum value of the power consumption when the rotor performs the rotation operation performs the rotation operation, for example. On the other hand, the vibration frequency estimator 15 may determine that the rotor is stopped when the power consumption value is lower than the threshold. As an alternative to the above-mentioned configuration, it is also sufficient when each of the time-to-frequency converter 13, the candidate detector 14, the vibration frequency estimator 15, and the abnormality determiner 16 does not use the frame when the rotor does not perform the rotation operation by referring to the operation information. Each of the time-to-frequency converter 13, the candidate detector 14, the vibration frequency estimator 15, and the abnormality determiner 16 may also execute the processing according to the above-mentioned embodiment with regard to the frame when the rotor performs the rotation operation. Accordingly, the abnormality detecting device may more accurately identify the vibration frequency equivalent to the rotation period of the rotor and also more certainly avoid the false detection of the abnormality that has occurred in the rotor.

According to another modified example, the abnormality determiner 16 may compare the power of the component at the vibration frequency with the abnormality determination threshold at the vibration frequency equivalent to the rotation period of the fan and the vibration frequency obtained by multiplying the vibration frequency equivalent to the rotation period by the number of blades included in the fan. In this case, the abnormality determiner 16 may estimate a cause of the abnormality in accordance with the vibration frequency at which the power becomes higher than or equal to the abnormality determination threshold.

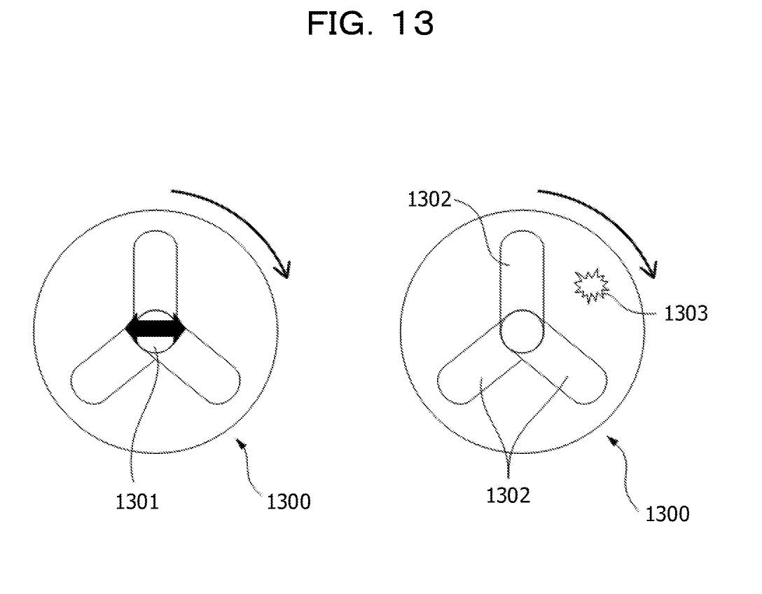

FIG. 13 illustrates an example of a relationship between the rotational vibration of the fan and an abnormal sound generating period. A shaft 1301 of the fan 1300 vibrates along a rotation of the fan 1300 in an example illustrated on the left side of FIG. 13. As a result, the fan 1300 generates the abnormal sound. In this case, the vibration of the shaft 1301 is almost equal to the rotation period of the fan 1300. For this reason, the generating period of the abnormal sound is also almost equal to the rotation period of the fan 1300. Therefore, in the frequency spectrum, the component equivalent to the abnormal sound appears at the vibration frequency equivalent to the rotation period of the fan.

In an example illustrated on the right side of FIG. 13, blades 1302 included in the fan 1300 collide with a foreign matter 1303, and the abnormal sound is generated. For this reason, the generating period of the abnormal sound becomes a period obtained by dividing the rotation period of the fan 1300 by the number of blades 1302 included in the fan 1300. Therefore, in the frequency spectrum, the component equivalent to the abnormal sound appears at the vibration frequency obtained by multiplying the vibration frequency equivalent to the rotation period of the fan by the number of blades included in the fan.

For example, when the vibration frequency at which the power becomes higher than or equal to the abnormality determination threshold is the vibration frequency equivalent to the rotation period of the fan, the abnormality determiner 16 may estimate that the cause of the abnormality is wobbling of the shaft of the fan. The abnormality determiner 16 may estimate the cause of the abnormality is the collision between the foreign matter and the blade when the vibration frequency at which the power becomes higher than or equal to the abnormality determination threshold is the vibration frequency obtained by multiplying the vibration frequency equivalent to the rotation period of the fan by the number of blades included in the fan. The abnormality determiner 16 may cause the user interface 4 to display the estimated cause of the abnormality together with the result of the abnormality detection.

According to this modified example, since the abnormality detecting device further limits the vibration frequency used for the determination of the abnormality detection, the false detection indicating that the abnormality exists in the fan based on periodic sound emitted by another object may be more appropriately avoided. This abnormality detecting device may present the estimated cause of the abnormality to a user.

According to another modified example, the abnormality determiner 16 may select the plurality of frames from the period where it is determined that the fluctuation in the power becomes lower than or equal to the certain level with regard to the identified vibration frequency equivalent to the rotation period of the fan. The abnormality determiner 16 may compare the power of the frequency component with the abnormality determination threshold at both the vibration frequency equivalent to the rotation period of the fan and the vibration frequency corresponding to the integer multiple of the vibration frequency for each of the selected frames. The abnormality determiner 16 may determine that the abnormality exists in the fan in a case where the number of frames in which the power becomes higher than or equal to the abnormality determination threshold becomes higher than or equal to the predetermined number at one of the vibration frequency equivalent to the rotation period of the fan and the vibration frequencies corresponding to the integral multiples of the identified vibration frequency. The predetermined number is set as an integer higher than or equal to 2 such as, for example, a third or half of the total number of frames in which the frequency spectrum is calculated.

According to this modified example, since the abnormality detecting device determines whether or not the abnormality exists in the fan depending on whether or not the component of the vibration frequency having the power higher than or equal to the abnormality determination threshold exists with regard to the plurality of frames, the abnormality of the fan may be more accurately detected.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An abnormality detecting device comprising:
a memory; and
a processor coupled to the memory and configured to:
detect an envelope of a sound signal representing a periodic sound emitted from the rotor including a predetermined number of blades and a periodic sound emitted from another object;
perform a time frequency transform of the envelope for each of frames having a predetermined time length and calculate a frequency spectrum of the sound signal for each of the frames;
detect a candidate of a frequency equivalent to a period of the sound emitted from the rotor in the frame based on a peak included in the frequency spectrum with regard to the frame for each of the frames; and
obtain a duration in which a fluctuation in power with respect to power of a component of the frequency spectrum in the candidate detected with regard to the frame becomes lower than or equal to a certain level for each of the frames and identify the candidate in which the duration becomes longest as the frequency equivalent to the period of the sound emitted from the rotor.

2. The abnormality detecting device according to claim 1, wherein the processor is further configured to
detect a plurality of peaks of the frequency spectrum for each of the frames;
calculate, for each pair including two peaks among the plurality of peaks, a ratio of one frequency to the other frequency of the two peaks included in the pair; and
detect the lower frequency among the frequencies of the two peaks included in the pair where a difference between the ratio and the predetermined number becomes minimum among the pairs as the candidate of the frequency equivalent to the period of the sound emitted from the rotor in the frame.

3. The abnormality detecting device according to claim 1, wherein the processor is further configured to:
determine whether or not an abnormality occurs in the rotor based on a component of the frequency equivalent to the period of the sound emitted from the rotor in the frequency spectrum with regard to any one of the plurality of frames where the fluctuation in the power with respect to the candidate in which the duration becomes longest becomes lower than or equal to the certain level.

4. The abnormality detecting device according to claim 3, wherein the processor is further configured to:
determine that the abnormality occurs in the rotor in a case where the number of frames where the power of the component at the frequency equivalent to the period of the sound emitted from the rotor in the frequency spectrum becomes higher than or equal to a predetermined threshold among the plurality of frames where the candidate in which the fluctuation in the power with respect to the duration becomes longest becomes lower than or equal to the certain level is higher than or equal to a predetermined number.

5. The abnormality detecting device according to claim 1, wherein the processor is further configured to:
obtain a period during which the frames having power at the frequency equivalent to the candidate where an absolute value of a difference with respect to the power in the candidate with regard to the frame becomes lower than or equal to a predetermined threshold are continuous as the duration with regard to the frame for each of the frames.

6. The abnormality detecting device according to claim 5, wherein the processor is further configured to:
include the continuous frames in the duration in a case where the number of continuous frames where the absolute value of the difference is higher than the predetermined threshold is lower than or equal to a predetermined allowable number.

7. The abnormality detecting device according to claim 1, wherein the processor is further configured to:
obtain duration to a farthest frame having power in a frequency equivalent to the candidate in which an absolute value of a difference with respect to the power in the candidate with regard to the frame becomes lower than or equal to a predetermined threshold as the duration with regard to the frame for each of the frames.

8. The abnormality detecting device according to claim 1, wherein the processor is further configured to:
obtain the duration based on the frame in a period during which the rotor performs a rotation operation which is identified based on operation information received from a device including the rotor which indicates whether or not the rotor performs the rotation operation.

9. An abnormality detection method for detecting an abnormality of a rotor, the abnormality detection method comprising:
detecting an envelope of a sound signal representing a periodic sound emitted from the rotor including a predetermined number of blades and a periodic sound emitted from another object;
performing a time frequency transform of the envelope for each of frames having a predetermined time length and calculating a frequency spectrum of the sound signal for each of the frames;
detecting a candidate of a frequency equivalent to a period of the sound emitted from the rotor in the frame based on a peak included in the frequency spectrum with regard to the frame for each of the frames; and
obtaining a duration in which a fluctuation in power with respect to power of a component of the frequency spectrum in the candidate detected with regard to the frame becomes lower than or equal to a certain level for each of the frames and identifying the candidate in which the duration becomes longest as the frequency equivalent to the period of the sound emitted from the rotor.

10. A non-transitory computer-readable recording medium storing a program for causing a computer to execute a process, the process comprising:
detecting an envelope of a sound signal representing a periodic sound emitted from the rotor including a predetermined number of blades and a periodic sound emitted from another object;
performing a time frequency transform of the envelope for each of frames having a predetermined time length and calculating a frequency spectrum of the sound signal for each of the frames;
detecting a candidate of a frequency equivalent to a period of the sound emitted from the rotor in the frame based on a peak included in the frequency spectrum with regard to the frame for each of the frames; and
obtaining a duration in which a fluctuation in power with respect to power of a component of the frequency spectrum in the candidate detected with regard to the frame becomes lower than or equal to a certain level for each of the frames and identifying the candidate in which the duration becomes longest as the frequency equivalent to the period of the sound emitted from the rotor.
